(19) United States
(12) Patent Application Publication
(10) Pub. No.: US 2022/0385479 A1
(43) Pub. Date: Dec. 1, 2022

(54) MULTI-MESSAGE MULTI-USER SIGNATURE AGGREGATION

(71) Applicants: BROWN UNIVERSITY, Providence, RI (US); WORCESTER POLYTECHNIC INSTITUTE, Worcester, MA (US)

(72) Inventors: Jeffrey HOFFSTEIN, Providence, RI (US); Joseph SILVERMAN, Needham, MA (US); Berk SUNAR, Boylston, MA (US); Yarkin DOROZ, Worcester, MA (US)

(21) Appl. No.: 17/642,647

(22) PCT Filed: Sep. 11, 2020
(86) PCT No.: PCT/US20/50378

§ 371 Date: Mar. 11, 2022

Related U.S. Application Data
(60) Provisional application No. 62/900,246, filed on Sep. 13, 2019.
(60) Provisional application No. 63/015,212, filed on Apr. 24, 2020.

(51) Int. Cl. H04L 9/32; H04L 9/00

(52) U.S. Cl. CPC H04L 9/3255; H04L 9/008

(57) ABSTRACT

A PQ signature scheme MMSAT that is capable of aggregating and compressing unrelated messages signed individually by different parties. The scheme extends the notion of multi-signatures, which are signatures that support aggregation of signatures on a single message signed by multiple parties.

### CROSS REFERENCE TO RELATED APPLICATIONS

This application claims the benefit of U.S. Ser. No. 62/900,246, filed Sep. 13, 2019, and U.S. Ser. No. 63/015,212, filed Apr. 24, 2019.

### STATEMENT REGARDING GOVERNMENT INTEREST

This invention was made with government support under Grant No. CNS-1561709 and Grant No. CNS-1561536 awarded by the National Science Foundation. The government has certain rights in the invention.

### BACKGROUND OF THE INVENTION

The present invention relates generally to document identification over computer networks or other types of communication systems and, more particularly, to a scheme for multi-message multi-user signature aggregation.

In general, traditional cryptographic schemes providing encryption, key encapsulation, and signature services are expected to be replaced by quantum-resistant schemes in deployments during the next decade. The threat is so urgent that the US National Institute of Standards and Technology started a standardization competition in 2018 to select one or more so-called Post-Quantum (PQ) schemes. PQ signature schemes are expected to play a vital role in protecting the integrity of data in storage, during transmission, and even during computation.

While techniques such as multi-signatures are useful for compressing multiply signed individual transactions, the bulk of the transactions on Bitcoin™ and other networks are signed by different users. Therefore, new blocks are mostly made up of transactions with separate signatures that are not compressible by existing multi-signature schemes.

Moreover, prior schemes use traditional cryptographic primitives that assume hardness in the traditional non-quantum model. There is an urgent need for PQ signature schemes that allow aggregation.

Compression and aggregation of individual PQ signatures and of public keys remain a challenge.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a method for signing and subsequently verifying a collection of digital messages including in at least one processor-based subsystem, selecting parameters that include two rings Ring1 and Ring2 and a module Mod, a ring homomorphism RHom from Ring1 to Ring2, a linear transformation THom from Ring2 to Mod, one or more range-defining bounds, and one or more formatted hash functions, for each User_i selecting a private key PrivKey_i that includes an element f_i in the Ring1 satisfying a first set of predetermined conditions and selecting an associated public key PubKey_i that includes the value Rhom(f_i), for each User_i selecting a digital document Doc_i and an element Rand_i in Ring1 satisfying a second set of predetermined conditions, and computing a signature Sig_i that includes elements C_i and Z_i in Ring1, wherein C_i is the output of a function whose input includes one or more quantities derived from THom(RHom(Rand_i)), Doc_i, and PubKey_i, and wherein the element Z_i is the output of a function whose input includes PrivKey_i, Rand_i, and C_i, and wherein Z_i satisfies a third set of predetermined conditions, aggregating a collection of signatures Sig_1, . . . , Sig_K on documents Doc_1, . . . , Doc_K to form an aggregate signature AggSig that includes quantities Z, Y, Y_1, . . . , Y_K, wherein the element Y is in Ring2 and is computed as the output of a function whose input includes RHom(Rand_1), . . . , RHom(Rand_K), wherein the elements Y_1, . . . , Y_K are in Mod and wherein each Y_i is computed as the output of a function whose input includes THom(RHom(Rand_i)), and wherein the element Z is in Ring1 and is computed as the output of a function whose input includes C_1, . . . , C_K and Z_1, . . . , Z_K, and verifying the validity of the aggregate signature AggSig on the documents Doc_1, . . . , Doc_K for the public keys PubKey_1, . . . , PubKey_K by a process that includes verifying that the quantities Z, Y, Y_1, . . . , Y_K satisfy a fourth set of predetermined conditions.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram of an exemplary system that can be used in practicing embodiments of the present invention.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Post-Quantum (PQ) signature schemes are known for large key and signature sizes, which may inhibit their deployment in real world applications. The present invention is a PQ signature scheme MMSAT that is a scheme capable of aggregating and compressing unrelated messages signed individually by different parties. The present invention extends the notion of multi-signatures, which are signatures that support aggregation of signatures on a single message signed by multiple parties. Multi-signatures are especially useful in Blockchain applications, where a transaction may be signed by multiple users. The present invention achieves significant gains in bandwidth and storage requirements by allowing aggregation and compression of multi-key and multi-message transactions. The present invention is derived by extending the PASS_{RS} scheme, so the security of the scheme relies on the hardness of the Vandermonde-SIS problem. When aggregated and compressed, a signature includes two parts. The first part is a post-quantum size signature that grows very slowly, scaling by on the order of log K bits for K signatures. The second part scales linearly with K, but bears only a short fixed cost of 2λ bits per signature, where λ represents the security parameter. Even for a modest number of signatures, the overhead of MMSAT is in line with that of traditional signature schemes such as the Elliptic Curve Digital Signature Algorithm (ECDSA). The present invention additionally includes a variant MMSATK of MMSAT that is capable of aggregating and compressing the public keys used by different parties.

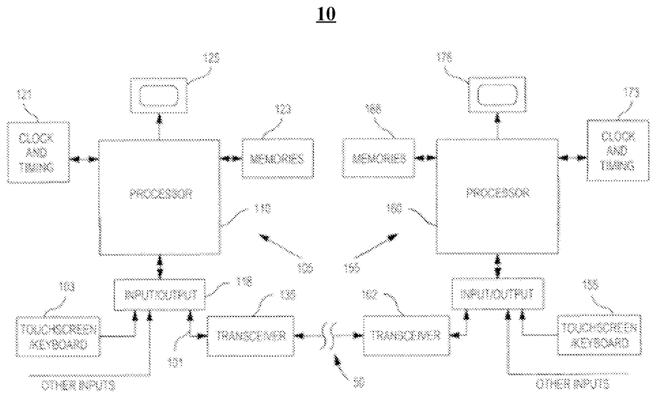

Referring now to FIG. 1, an exemplary system 10 that can be used in practicing embodiments of the invention includes two processor-based subsystems 105 and 155 that are in communication over a channel 50, which may be, for example, any wired or wireless communication channel such as a telephone or internet communication channel in, for example, a cloud-based system. In the example hereof, the channel can be considered a secure or an insecure channel. The subsystem 105 includes processor 110 and the subsystem 155 includes processor 160. The subsystems may typically include mobile devices, computers, or terminals. When programmed in the manner to be described, the processors 110 and 160 and their associated circuits may be used to implement an embodiment of the present invention and to practice an embodiment of the method of the invention. The processors 110 and 160 may each be any suitable processor, for example, an electronic digital processor or microprocessor. It should be understood that any general purpose or special purpose processor, or other machine or circuitry that can perform the functions described herein, electronically, optically, or by other means, can be utilized. The subsystem 105 typically includes memories 123, clock and timing circuitry 121, input/output functions 118 and display 125. Inputs can include a touchscreen/keyboard input as represented at 103. Communication is via transceiver 135, which may include any suitable device for communicating signals.

The subsystem 155 in this illustrative embodiment can have a similar configuration to that of subsystem 105. The processor 160 has associated input/output circuitry 164, memories 168, clock and timing circuitry 173, and a display 176. Inputs include a touchscreen/keyboard 155. Communication of subsystem 155 with the outside world is via transceiver 162.

The present invention is a PQ signature scheme, referred to herein as “MMSAT,” which supports aggregation across unrelated signatures signed by different users. An aggregated MMSAT signature has size roughly equal to a single PQ signature plus 2λ-bits per signature aggregated. From a practical perspective, even for a modest number of signatures (e.g., a few hundred), the aggregate signature size of MMSAT represents an improvement over traditional signature schemes such as elliptic curve-based signatures (ECDSA), e.g. it is 19-times smaller than Bimodal Lattice Signature Scheme (BLISS) and 1.9 times smaller than ECDSA for 1000 signatures at 128-bit security.

The present invention uses an ∞-norm analysis to give improved estimates for the forgery probability from lattice reduction, leading to optimized parameters.

The present invention is a method and system for multiple users to sign multiple documents, for those signatures to be aggregated and compressed based on ring homomorphisms and linear transformations, and for the users' public keys to be aggregated and compressed based on ring homomorphisms and linear transformations. The ring homomorphism may utilize two rings Ring1 and Ring2 and a module Mod, a ring homomorphism RHom: Ring1-->Ring2, and a linear transformation THom: Ring2-->Mod. The private keys can include elements f lying in a specified subset of Ring1, the public keys can include the value RHom(f) in Ring2, the individual signatures in accordance with the invention may include quantities computed from the individual documents and individual private and public keys via specified formatted hash functions and algebraic operations in the ring Ring1 and applications of the maps RHom and THom, and the aggregated and compressed signature on the collection of documents may include quantities computed from the individual signatures, the individual documents, and the individual public keys via specified formatted hash functions and algebraic operations in the rings Ring1 and Ring2 and applications of the maps RHom and THom.

Table 1, shown below, lists public parameters used variously by PASS_{RS} and MMSAT and MMSATK.

TABLE 1
Public parameters for PASS_{RS}, MMSAT, and MMSATK

| | |
|---|---|
| N | a prime (dimension parameter) |
| q | a prime satisfying q ≡ 1 (mod N) (modulus parameter) |
| g | a primitive N^{th} root of unity in Z_{q} |
| R_{q} | the ring Z_{q}[x]/(x^{N} − 1), often identified with Z_{q}^{N} with |
| | multiplication * |
| * | multiplication in R_{q}, convolution product in Z_{q}^{N} |
| ⊙ | coordinate-by-coordinate multiplication in R_{q} ≅ Z_{q}^{N} |
| λ | bit security parameter |
| [symbol] | space of message digests μ ∈ [symbol] |
| Ω | a subset of {g^{j}:1 ≤ j ≤ N − 1} |
| t | =\|Ω\|, the number of elements in Ω |
| Bₜ | ≈t/N, parameter used to select t |
| [symbol] | dimension parameter for signature compression map T, |
| | satisfies [symbol] ≥ [symbol] |
| t′ | $\begin{matrix}dimension parameter for key compression , \\ satisfies {q}^{{t}^{′}} \geq \text{?} and ( \begin{matrix}t \\ {t}^{′}\end{matrix} ) \geq \text{?}\end{matrix}$ |
| k | L^{∞}-norm bound for commitment polynomial y |
| b | L^{∞}-norm bound for rejection sampling is k − b |
| K | number of individual signatures contained in an aggregate |
| | signature |
| Bₖ, B_{q} | multipliers used for L¹-norm bounds for aggregate signature, |
| | related by B\sqrt{K}(k − b) ≈ B_{q}q. |
| dₑ | the number of 1's and −1's in a challenge polynomial, dₑ ≤ b/2 |
| d_{f} | the number of 1's and −1's in a private key |
| T | a Z_{q}-linear map T:Z_{q}^{t} → Z_{q} [symbol] used for compression |
| Hash_{C} | a hash/encoder function {0, 1} [symbol] → [symbol] (dₑ) |
| Hash_{B} | a hash/encoder function {0, 1} [symbol] → {−1, 1} [symbol] |
| Hash_{Ω} | a hash/encoder function {0, 1} [symbol] → {subsets of Ω containing |
| | t′ elements} |

[symbol]

indicates data missing or illegible when filed

In Table 2, an exemplary sign algorithm for individual signatures is shown.

TABLE 2
Sign Algorithm for PASS_{RS} and MMSAT and MMSATK.
The input to Hash_{C} depends on the particular scheme
Algorithm 1 Sign

| Input: (μ, f, Scheme) | |
|---|---|
| 1: | repeat |
| 2: | $y {←}^{\text{?}} {ℬ}^{∞} ( k )$ |
| 3: | c ← Hash_{C}(Scheme, μ) |
| 4: | z ← f * c + y |
| 5: | $until z ∈ {ℬ}^{∞} ( k - b )$ |

Output: (ŷ|_{Ω}, z, μ)

$\text{?} \text{indicates text missing or illegible when filed}$

In Table 3, an exemplary verification algorithm for individual signatures is shown.

TABLE 3
Verify Algorithm for PASS_{RS} and MMSATK. The
input to Hash_{C} depends on the particular scheme
Algorithm 2 Verify

| Input: (ŷ\|_{Ω}, z, μ, \hat{f}\|_{Ω}, Scheme) | |
|---|---|
| 1: | c ← Hash_{C}(Scheme, μ) |
| 2: | Z ← \hat{f}\|_{Ω} ⊙ ĉ\|_{Ω} + ŷ\|_{Ω} |
| 3: | if z ϵ B^{∞} (k − b) and Z = \hat{z}\|_{Ω} then |
| 4: | result ← valid |
| 5: | else |
| 6: | result ← invalid |
| 7: | end if |

Output: result

In Table 4, an exemplary MMSAT aggregate signature algorithm is shown.

TABLE 4
MMSAT: Aggregate Signature Algorithm
with Signature Compression
Algorithm 3 Aggregate

| Input: ( [symbol] \|_{Ω}, zᵢ, μᵢ, [symbol] \|_{Ω})_{iϵ[K]} | |
|---|---|
| 1: | for i := 1 to K step 1 do |
| 2: | cᵢ ← Hash_{C}(T(ŷ\|_{Ω}), μᵢ, [symbol] \|_{Ω}) |
| 3: | end for |
| 4: | β ← Hash_{B}(c₁,..., c_{K}) |
| 5: | z ← β₁z₁ + ... + β_{K}z_{K} |
| 6: | Y ← β₁ [symbol] \|_{Ω} + ... + β_{K} [symbol] \|_{Ω} |
| 7: | if \|\|z\|\|_{∞} ≤ Bₖ\sqrt{K}(k − b) then |
| 8: | result ← success |
| 9: | else |
| 10: | result ← failture |
| 11: | end if |

Output: (z, Y, μᵢ, T( [symbol] |_{Ω}))_{iϵ[K]}, result

In Table 5, an exemplary MMSAT verify aggregate signature algorithm is shown.

TABLE 5
MMSAT: Aggregate Signature Verification Algorithm
Algorithm 4 VerifyAggregate

| Input: (z, Y, μᵢ, T(ŷᵢ\|_{Ω}), \hat{f}ᵢ\|_{Ω})_{i∈[K]} | |
|---|---|
| 1: | for i := 1 to K step 1 do |
| 2: | cᵢ ← Hash_{C}(T(ŷᵢ\|_{Ω}), μᵢ, \hat{f}ᵢ\|_{Ω}) |
| 3: | end for |
| 4: | β ← Hash_{B}(c₁ , . . . , c_{K}) |
| 5: | $Z ← ( {\sum }_{i = 1}^{K} {β}_{i} ( {\hat{{f}_{i} │}}_{Ω} ⊙ \hat{{c}_{i}} {│}_{Ω} ) ) + Y$ |
| 6: | $W ← ( {\sum }_{i = 1}^{K} {β}_{i} T ( \hat{{y}_{i}} {│}_{Ω} ) )$ |
| 7: | if ∥z∥_{∞} ≤ Bₖ\sqrt{K}(k − b) and |
| | c₁ , . . . , c_{K} are distinct and |
| | T(Y) = W and Z = \hat{z}\|_{Ω} then |
| 8: | result ← valid |
| 9: | else |
| 10: | result ← invalid |
| 11: | end if |

Output: result

In Table 6, an exemplary MMSAT sign algorithm with public key compression is illustrated.

TABLE 6
MMSATK: Aggregate Signature Algorithm
with Public Key Compression
Algorithms 5 Aggregate

| Input: ( [symbol] \|_{Ω}, zᵢ, μᵢ, [symbol] \|_{Ω})_{iϵ[K]} | |
|---|---|
| 1: | for i := 1 to K step 1 do |
| 2: | Yᵢ ← T( [symbol] \|_{Ω}) |
| 3: | Fᵢ ← T( [symbol] \|_{Ω}) |
| 4: | cᵢ ← Hash_{C}(Yᵢ, μᵢ, Fᵢ) |
| 5: | end for |
| 6: | β ← Hash_{B}(ci,...,c_{K}) |
| 7: | z ← β₁z₁ + ... + β_{K}z_{K} |
| 8: | Y ← β₁ [symbol] \|_{Ω} + ... + β_{K} [symbol] \|_{Ω} |
| 9: | Ω′ ← Hash_{Ω}(z, y, c₁,..., c_{K}) |
| 10: | for i := 1 to K step 1 do |
| 11: | Fᵢ′ ← [symbol] \|_{Ω′} |
| 12: | Yᵢ′ ← [symbol] \|_{Ω′} |
| 13: | end for |
| 14: | if \|\|z\|\|_{∞} ≤ Bₖ\sqrt{K}(k − b) then |
| 15: | result ← success |
| 16: | else |
| 17: | result ← failture |
| 18: | end if |
| Output: (z, Y, μᵢ, Yᵢ, Yᵢ′, Fᵢ, Fᵢ′)_{iϵ[K]}, | |
| | result |

In Table 7, an exemplary MMSAT verify individual signature with compressed public key algorithm is shown.

TABLE 7
MMSATK: Aggregate
Verification Algorithm with Compressed Public Key
Algorithm 6 VerifyAggregate

| Input: (z, Y, μᵢ, Yᵢ, Yᵢ′, Fᵢ, Fᵢ′,)_{i∈[K]} | |
|---|---|
| 1: | for i := 1 to K step 1 do |
| 2: | cᵢ ← Hash_{C}(Yᵢ, μᵢ, Fᵢ) |
| 3: | end for |
| 4: | β ← Hash_{B}(c₁ , . . . , c_{K}) |
| 5: | Ω′ ← Hash_{Ω}(z, Y, c₁ , . . . , c_{K}) |
| 6: | ${Z}^{′} ← ( {\sum }_{i = 1}^{K} {β}_{i} ( {F}_{i}^{′} ⊙ \hat{{c}_{i}} {│}_{{Ω}^{′}} ) ) + {Y │}_{{Ω}^{′}}$ |
| 7: | ${W}^{′} ← {\sum }_{i = 1}^{K} {β}_{i} {Y}_{i}^{′}$ |
| 8: | if ∥z∥_{∞} ≤ Bₖ\sqrt{K}(k − b) and |
| | c₁ , . . . , c_{K} are distinct and Z′ = |
| | \hat{z}\|_{Ω′} and W′ = Y\|_{Ω′} then |
| 9: | result ← valid |
| 10: | else |
| 11: | result ← invalid |
| 12: | end if |

Output: result

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method for signing and subsequently verifying a collection of digital messages comprising:
in at least one processor-based subsystem, selecting parameters that include two rings Ring1 and Ring2 and a module Mod, a ring homomorphism RHom from Ring1 to Ring2, a linear transformation THom from Ring2 to Mod, one or more range-defining bounds, and one or more formatted hash functions;
for each User_i selecting a private key PrivKey_i that includes an element f_i in the Ring1 satisfying a first set of predetermined conditions and selecting an associated public key PubKey_i that includes the value RHom(f_i);
for each User_i selecting a digital document Doc_i and an element Rand_i in Ring1 satisfying a second set of predetermined conditions, and computing a signature Sig_i that includes elements C_i and Z_i in Ring1,
wherein C_i is the output of a function whose input includes one or more quantities derived from THom(RHom(Rand_i)), Doc_i, and PubKey_i, and wherein the element Z_i is the output of a function whose input includes PrivKey_i, Rand_i, and C_i, and wherein Z_i satisfies a third set of predetermined conditions;
aggregating a collection of signatures Sig_1, . . . , Sig_K on documents Doc_1, . . . , Doc_K to form an aggregate signature AggSig that includes quantities Z, Y, Y_1, . . . , Y_K, wherein the element Y is in Ring2 and is computed as the output of a function whose input includes RHom(Rand_1), . . . , RHom(Rand_K), wherein the elements Y_1, . . . , Y_K are in Mod and wherein each Y_i is computed as the output of a function whose input includes THom(RHom(Rand_i)), and wherein the element Z is in Ring1 and is computed as the output of a function whose input includes C_1, . . . , C_K and Z_1, . . . , Z_K; and
verifying the validity of the aggregate signature AggSig on the documents Doc_1, . . . , Doc_K for the public keys PubKey_1, . . . , PubKey_K by a process that includes verifying that the quantities Z, Y, Y_1, . . . , Y_K satisfy a fourth set of predetermined conditions.

2. The method of claim 1 wherein Ring1 is equipped with one or more functions that measure a size of the elements of Ring1.

3. The method of claim 2 wherein the first set of predetermined conditions includes the condition that the size of the ring element f_i using the first size measure is less than the first range-defining bound.

4. The method of claim 2 wherein the second set of predetermined conditions includes the condition that the size of the ring element Rand_i using the second size measure is less than the second range-defining bound.

5. The method of claim 2 wherein the third set of predetermined conditions includes the condition that the size of the ring element Z_i using the third size measure is less than the third range-defining bound.

6. The method of claim 2 wherein the fourth set of predetermined conditions includes the condition that the size of the ring element Z using the fourth size measure is less than the fourth range-defining bound.

7. The method of claim 1 wherein the quantity C_i is computed as the output of the first formatted hash function evaluated at a list of inputs that includes THom(RHom(Rand_i)), Doc_i, and PubKey_i.

8. The method of claim 1 wherein the quantity Z_i is computed using the sum of Rand_i and the product of PrivKey_i and C_i in Ring1.

9. The method of claim 1 wherein linear functions L1, L2, L3 are determined using the output of the second formatted hash function evaluated at quantities that include C_1, . . . , C_K, wherein L1 is a linear function from Ring1 to Ring1, wherein L2 is a linear function from Ring2 to Ring2, wherein L3 is a linear function from Mod to Mod, wherein RHom composed with L1 equals L2 composed with RHom, and wherein THom composed with L2 equals L3 composed with THom.

10. The method of claim 9 wherein the functions L1, L2 and L3 are linear forms with small non-zero integer coefficients.

11. The method of claim 9 wherein the quantity Z is computed using the output of the function L1 evaluated at Z_1, . . . , Z_K.

12. The method of claim 9 wherein the quantity Y is computed using the output of the function L2 evaluated at RHom (Rand_1), . . . , RHom(Rand_K).

13. The method of claim 9 wherein the fourth set of predetermined conditions includes the condition that RHom(Z) is equal to Y plus L2 evaluated at RHom(f_1)*RHom(D_1), . . . , RHom(f_K)*Rhom(D_K), wherein the quantity D_i is computed as the output of the first formatted hash function evaluated at a list of inputs that includes Y_i, Doc_i, and PubKey_i.

14. The method of claim 9 wherein the fourth set of predetermined conditions includes the condition that THom(Y) is equal to L3 evaluated at Y_1, . . . , Y_K.

15. The method of claim 1 wherein the fourth set of predetermined conditions includes the condition that the quantities D_1, . . . , D_K are distinct, wherein the quantity D_i is computed as the output of the first formatted hash function evaluated at a list of inputs that includes Y_i, Doc_i, and PubKey_i.

16. The method of claim 1 wherein F_q is a finite field and Ring1 and Ring2 are finite F_q-algebras and M is a finite F_q-vector space and RHom is an F_q-algebra homomorphism and THom is an F_q-linear transformation.

17. The method of claim 16 wherein multiplication in Ring1 is convolution product and multiplication in Ring2 is coordinate-by-coordinate product, and RHom is a finite Fourier transform following by a projection onto one or more coordinates.

18. The method of claim 16 wherein the dimensions of Ring1 and Ring2 as vector spaces over F_q are prime.

19. The method of claim 16 wherein the size measures on Ring1 are computed using the values of specified F_q-coordinates centered into the range from −q/2 to q/2.

20. The method of claim 16 wherein the coefficients of the linear transformation THom satisfy the fifth range-defining bound.

21. The method of claim 1 wherein the digital document Doc_i is selected as the output of the third formatted hash function evaluated at an unencrypted and unhashed digital document UEDoc_i.

22. The method of claim 1 wherein the element Z in Ring1 is computed as the output of a function whose input additionally includes Doc_1, . . . , Doc_K.

23. The method of claim 9 wherein the input to the second formatted hash function additionally includes some or all of the quantities Y_1, . . . , Y_K, Doc_1, . . . , Doc_K, PubKey_1, . . . , PubKey_K.

24. The method of claim 1 wherein the module M is equal to the ring Ring2 and the linear transformation THom is the identity map.

25. The method of claim 5 wherein the third range-defining bound is chosen so that a list of signatures signed by one private key is indistinguishable from a list of signatures signed by a second private key.

26. The method of claim 1 wherein the parameters additionally include a ring Ring2′, a function whose input includes elements Z, C_1, . . . , C_K of Ring1 and an element Y of Mod and whose output is a homomorphism PHom from Ring2 to Ring2′, and a linear function L2′ from Ring2′ to Ring2′ such that PHom composed with L2′ is equal to L2 composed with PHom, and wherein the aggregate signature AggSig additionally includes elements Y_1′, . . . , Y_K′, F_1, . . . F_K, F_1′, . . . , F_K′, wherein Y_1′, . . . , Y_K′ are in Ring2′ and wherein each Y_i′ is computed as the output of a function whose input includes PHom (Z, C_1, . . . , C_K, Y; RHom(Rand_i)), and wherein the elements F_1, . . . , F_K are in Mod and wherein each F_i is computed as the output of a function whose input includes THom(RHom(f_i)), and wherein the elements F_1′, . . . , F_K′ are in Ring2′ and wherein each F_i′ is computed as the output of a function whose input includes PHom (Z, C_1, . . . , C_K, Y; RHom(f_i)), and wherein the process of verifying the validity of the aggregate signature AggSig on the documents Doc_1, . . . , Doc_K for the public keys PubKey_1, . . . , PubKey_K includes verifying that the quantities Z, Y, Y_1, . . . , Y_K, Y_1′, . . . , Y_K′, F_1, . . . F_K, F_1′, . . . , F_K′ verify a fifth set of predetermined conditions.

27. The method of claim 1 wherein the quantity C_i is computed as the output of the first formatted hash function evaluated at a list of inputs that includes THom(RHom(Rand_i)), Doc_i, and THom(RHom(f_i)).

28. The method of claim 26 wherein the fifth set of predetermined conditions includes the condition that PHom(RHom(Z)) is equal to PHomZ (Y) plus L2′ evaluated at F_1′*PHom(RHom(D_1)), . . . , F_K′*PHom(RHom(D_K)), wherein the quantity D_i is computed as the output of the first formatted hash function evaluated at a list of inputs that includes Y_i, Doc_i, and F_i.

29. The method of claim 26 wherein the fifth set of predetermined conditions includes the condition that PHom(Y) is equal to L2′ evaluated at Y_1′, . . . , Y_K′.

30. The method of claim 26 wherein the coefficients of the linear transformation PHom satisfy the sixth range-defining bound.
